(19) United States
(12) Patent Application Publication
(10) Pub. No.: US 2005/0233182 A1
(43) Pub. Date: Oct. 20, 2005

(54) Method for real-time monitoring and control of cathode stoichiometry in fuel cell system

(76) Inventors: Robert L. Fuss, Spencerport, NY (US); Robert N. Carter, Honeoye Falls, NY (US); Bruce J. Clingerman, Palmyra, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 10/827,699

(22) Filed: Apr. 20, 2004

(51) Int. Cl. H01M 8/00

(52) U.S. Cl. 429/12; 429/18; 429/22; 429/13

(57) ABSTRACT

A fuel cell system that employs an oxygen sensor for measuring the oxygen concentration in the cathode exhaust gas from the fuel cell stack. A controller provides a signal that drives a compressor providing air to a cathode input of the stack so that the compressor provides the desired oxygen to achieve the desired cathode lambda. In one embodiment, the fuel cell system also employs an airflow meter that measures the amount of air being applied to the compressor. The controller compares the oxygen input applied to the stack to the oxygen output from the stack for diagnostic purposes, such as determining the presence of leaks. A temperature sensor can be employed to measure the temperature of the cathode exhaust and a pressure sensor can be employed to measure the pressure of the cathode exhaust to compensate for water vapor in the cathode exhaust.

### BACKGROUND OF THE INVENTION

1. Field of the Invention

This invention relates generally to a technique for controlling cathode stoichiometry in a fuel cell system and, more particularly, to a fuel cell system that employs an oxygen sensor at the cathode exhaust of the fuel cell stack to provide cathode stoichiometry control.

2. Discussion of the Related Art

Hydrogen is a very attractive fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is disassociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle.

Proton exchange membrane fuel cells (PEMFC) are a popular fuel cell for vehicles. The PEMFC generally includes a solid polymer electrolyte proton conducting membrane, such as a perflurosulfonic acid membrane. The anode and cathode typically include finely divided catalytic particles, usually platinum (Pt), supported on carbon particles and mixed with an ionomer. The combination of the anode, cathode and membrane define a membrane electrode assembly (MEA). MEAs are relatively expensive to manufacture and require certain conditions for effective operation. These conditions include proper water management and humidification, and control of catalyst poisoning constituents, such as carbon monoxide (CO).

Many fuel cells are typically combined in a fuel cell stack to generate the desired power. The fuel cell stack receives a cathode input gas as a flow of air, typically forced through the stack by a compressor or other air delivery device. Not all of the oxygen in the air is consumed by the stack and some of the air is output as a cathode exhaust gas that may include water as a stack by-product. The fuel cell stack also receives a hydrogen anode input gas that combines with the air to generate power as described above.

The fuel cell stack needs to put out a certain amount of power to provide the desired work. The amount of oxygen in air sent to the cathode relative to the amount of oxygen the stack consumes to meet the power requirement is referred to as cathode air stoichiometry or cathode lambda. Particularly, the cathode lambda is the amount of oxygen delivered to the stack, divided by the amount of oxygen that is consumed by the stack. Some fuel cell systems operate at a constant cathode lambda across the entire power output of the system. Other fuel cell systems operate at different cathode lambdas for different power outputs.

The greater the airflow applied to the cathode input, the more oxygen is applied to the stack. It is typical to supply additional airflow to the stack cathode to insure that all cathode reaction sites receive an adequate concentration of oxygen. Therefore, additional oxygen that is not consumed by the stack, for example 40%, is required to provide the output power of the stack. If more air is applied to the stack than is needed, the compressor and other fuel system components operate harder than is necessary to achieve the desired power output, thus reducing system efficiency. Therefore, it is desirable to provide the proper amount of input air to the stack, identified by the cathode lambda. The internal dynamics of the operation of the fuel cell stack determines what the proper cathode lambda is for a particular output power.

It is known in the art to employ an airflow meter that measures the airflow applied to the compressor to determine the amount of oxygen that is being applied to the stack. It is also known to employ an amp meter to measure the current output of the stack. The combination of the oxygen applied to the stack and the current output of the stack can be used to determine the cathode lambda at which the system is currently operating. A controller operates the compressor at the desired speed or torque to achieve the proper cathode lambda.

The performance of a fuel cell system is often evaluated by a test stand under laboratory conditions. In the test stand evaluation process, the cathode stoichiometry is generally controlled by a mass flow control valve (MFCV) that meters air to the cathode side of the fuel cell stack. The MFCV can be calibrated to provide an accurate flow of air, and thus ensure a known cathode stoichiometry while its calibration remains valid. However, a problem has been observed because known MFCV devices tend to lose their calibration over time, leading to inaccurate control of cathode stoichiometry.

Monitoring of the MFCV operation has been accomplished either by periodic checks of its calibration or by measuring the cathode exhaust with a gas chromatograph during stack operation, and then calculating the stoichiometry according to the following equation:

$$Stoic . = 21 / [ 21 - ( \frac{79 * {x}_{{0}_{2}}}{1 - {x}_{{0}_{2}}} ) ] ,$$

where x₀_{₂} is the gas molar concentration of oxygen in the cathode exhaust.

While the gas chromatograph measurements can provide accurate results, this type of analysis takes several minutes, which prohibits the gas analysis during a transient. Additionally, it is somewhat cumbersome to perform this analysis while the fuel cell is being operated, and thus requires the use of sampling bottles, which introduces a significant risk of operator error in measuring the oxygen concentration.

Another known technique for monitoring cathode stoichiometry on a faster time scale in a test stand environment includes the use of either a mass spectrometer or a paramagnetic oxygen analyzer positioned in the cathode exhaust. Both of these techniques could be used to quantify the oxygen content in the cathode exhaust, and have response times of several seconds. However, the mass spectrometer suffers the disadvantage that it is a fairly expensive instrument and requires frequent calibration to provide accurate quantitative measurements. The paramagnetic analyzer is somewhat less expensive than the mass spectrometer, but is extremely sensitive to liquid water exposure, which is a by-product in the cathode exhaust.

### SUMMARY OF THE INVENTION

In accordance with the teachings of the present invention, a fuel cell system is disclosed that employs an oxygen sensor for measuring the oxygen concentration in the cathode exhaust from the fuel cell stack. The percent of oxygen in the cathode exhaust gas is directly related to the cathode lambda. A controller converts the oxygen concentration to the cathode lambda. In one embodiment, the controller drives a compressor that provides air to a cathode input of the stack so that the compressor provides the desired oxygen to achieve the desired cathode lambda. The fuel cell system can employ an airflow meter that measures the airflow being applied to the compressor. The controller compares the airflow applied to the stack to the oxygen output from the stack for diagnostic purposes, such as determining the presence of leaks.

The performance of fuel cell systems is sometimes evaluated by a fuel cell test stand. An oxygen sensor can also be employed in the test stand for measuring the oxygen concentration in the cathode exhaust from the fuel cell stack. An MFCV is employed to meter the cathode gas to the fuel cell stack. The oxygen sensor provides a signal to a system controller indicative of the oxygen concentration in the cathode exhaust, and the system controller controls the MFCV so that the proper amount of air is input to the fuel cell stack for desired cathode stoichiometry.

In an alternate embodiment, the fuel cell system further includes a water separator positioned in the cathode exhaust upstream of the oxygen sensor to remove water from the cathode exhaust. The temperature of the cathode exhaust is measured by a temperature sensor and the pressure of the cathode exhaust is measured by a pressure sensor. Output signals from the temperature sensor and the pressure sensor are sent to the controller to calculate the water content of the cathode exhaust before it is measured by the oxygen sensor.

Additional advantages and features of the present invention will become apparent from the following description and appended claims, taken in conjunction with the accompanying drawings.

### BRIEF DESCRIPTION OF THE DRAWINGS

FIG. 1 is a graph with cathode air stoichiometry on the horizontal axis and percent oxygen in the cathode exhaust on the vertical axis that shows the relationship between the concentration of oxygen in the cathode exhaust gas of a fuel cell stack to the cathode oxygen stoichiometry;

FIG. 2 is a block diagram of a fuel cell system employing an oxygen sensor for determining cathode stoichiometry, according to an embodiment of the present invention;

FIG. 3 is a block diagram of a fuel cell system employing a mass flow control valve in the cathode input to the fuel cell stack and an oxygen sensor in the cathode exhaust of the fuel cell stack to control cathode stoichiometry, according to another embodiment of the present invention; and

FIG. 4 is a block diagram of a fuel cell system employing a mass flow control valve in the cathode input to the fuel cell stack and an oxygen sensor, a temperature sensor, a pressure sensor and a water vapor separator in the cathode exhaust of the fuel cell stack for controlling cathode stoichiometry, according to another embodiment of the present invention.

### DETAILED DESCRIPTION OF THE EMBODIMENTS

The following description of the embodiments of the invention directed to a fuel cell system employing an oxygen sensor in the cathode exhaust for controlling cathode stoichiometry is merely exemplary in nature, and is in no way intended to limit the invention or its applications or uses. For example, the fuel cell system described herein has particular application for vehicle propulsion. However, as will be appreciated by those skilled in the art, the fuel cell system of the invention has a much broader application for other systems that employ fuel cells, such as stationary power systems.

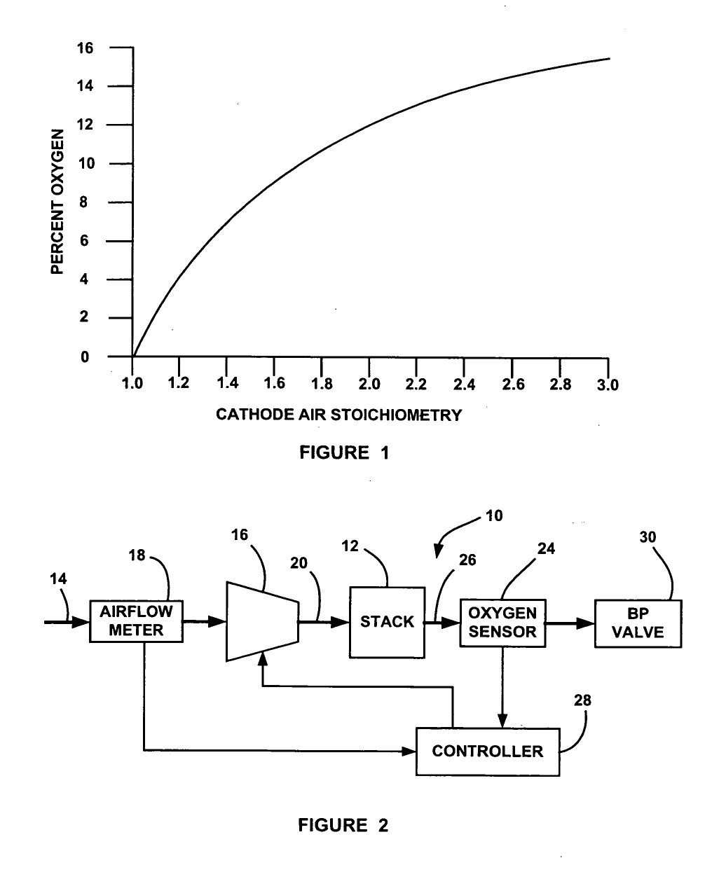

FIG. 1 is a graph with cathode oxygen stoichiometry (cathode lambda) on the horizontal axis and percent oxygen in the cathode exhaust on the vertical axis showing the relationship between the concentration of oxygen in the cathode exhaust gas of a fuel cell stack to its cathode lambda. As will be discussed in detail below, this relationship can be used to determine whether the proper amount of cathode input air is being applied to a fuel cell stack based on a measure of the percent of oxygen in the cathode exhaust gas.

FIG. 2 is a block diagram of a fuel cell system 10, according to an embodiment of the present invention. The fuel cell system 10 includes a fuel cell stack 12 having a stack of fuel cells, as discussed above. The fuel cell stack 12 receives a cathode air input and an anode hydrogen input that electrochemically interact to generate output power to drive a vehicle or some other system. An air input line 14 is applied to a compressor 16, or other air delivery device, that compresses the air and delivers the compressed air on line 20 to the cathode input of the stack 12. The anode input of the stack 12 is not shown because it does not form part of the present invention. The system 10 includes an airflow meter 18 that measures the airflow mass applied to the compressor 16 as is known in certain fuel cell systems in the art. As discussed above, the airflow meter 18 has been used in the industry to determine the cathode lambda of the stack 12. However, as will become apparent from the discussion below, the airflow meter 18 is not necessary in the present invention to perform this function.

According to the invention, the system 10 employs an oxygen sensor 24 through which flows cathode exhaust gas from the stack 12 on line 26. The oxygen sensor 24 can be any oxygen sensor suitable for the purposes discussed herein, such as an automotive exhaust oxygen sensor. The oxygen sensor 24 provides a signal indicative of the concentration of the oxygen in the cathode exhaust gas to a controller 28. By knowing the concentration of oxygen in the cathode exhaust gas, the controller 28 can determine the cathode lambda of the stack 12 based on the relationship shown in FIG. 1. The controller 28 provides a control signal to the compressor 16 to drive the compressor 16 at the appropriate speed so that the concentration of oxygen measured by the oxygen sensor 24 in the cathode exhaust gas provides the desired cathode lambda for the system 10. Therefore, the oxygen sensor 24 can replace the airflow meter 18 to determine the cathode lambda of the stack 12.

A back pressure valve 30 is provided in the cathode exhaust gas line 26 to control the output pressure of the cathode exhaust gas to maintain the proper relative humidity within the stack 12, as is understood in the art. The oxygen sensor 24 is shown upstream from the back pressure valve 30. However, in other embodiments the oxygen sensor 24 can be positioned downstream from the back pressure valve 30.

According to another embodiment of the present invention, the airflow meter 18 and the oxygen sensor 24 are used in combination for diagnostic purposes for the system 10. Typically, the airflow meter 18 is mounted at the input of the compressor 16 because the output gas of the compressor 16 is too hot for the airflow meter 18. Thus, the airflow meter 18 would not be able to determine whether an air leak exists downstream from the airflow meter 18. If a leak does exist upstream of the stack 12, the controller 28 would not detect it, and therefore the system 10 would not be getting the proper amount of oxygen because the airflow meter 18 is positioned upstream from the leak.

By employing the oxygen sensor 24, as discussed above, the controller 28 would drive the compressor 16 at the proper speed to overcome the leak because it would provide the additional oxygen necessary to provide the desired cathode lambda. By employing the airflow meter 18 in combination with the oxygen sensor 24, the controller 28 will know that the proper airflow is being provided to the compressor 16 to provide the desired cathode lambda, but the oxygen sensor 24 would indicate that the proper cathode lambda is not being achieved at the predicted airflow. This would indicate a problem within the system 10, such as a leak in the lines 20 or 26 or the stack 12.

Alternatively, the controller 28 can use a compressor map of the compressor 16 based on compressor speed and the compressor input/output pressure ratio to calculate the appropriate cathode lambda, and compare that calculation to the output from the oxygen sensor 24. Because the controller 28 will know the ΔP (delta pressure) across the compressor 16, the controller 28 will then be able to determine if an air leak exists for diagnostic purposes. If a much higher cathode lambda is expected, a system diagnostic warning is given indicative of a degrading compressor performance or an air leak somewhere in the system 10. The closed loop nature of the feedback can compensate for the problem until the system 10 is serviced.

Additionally, the oxygen sensor 24 can be used as a control for the airflow meter 18. It is known in the art that airflow meters used for this purpose tend to drift over time. Therefore, the oxygen sensor 24 can be used to determine the accuracy of the airflow meter 18, and compensate for its operation over time.

It is known in the art to employ a test stand in a laboratory environment to test the performance of a fuel cell stack during stack design and the like. According to the invention, an oxygen sensor can also be employed in the test stand system for measuring the oxygen concentration in the cathode exhaust to determine cathode stoichiometry.

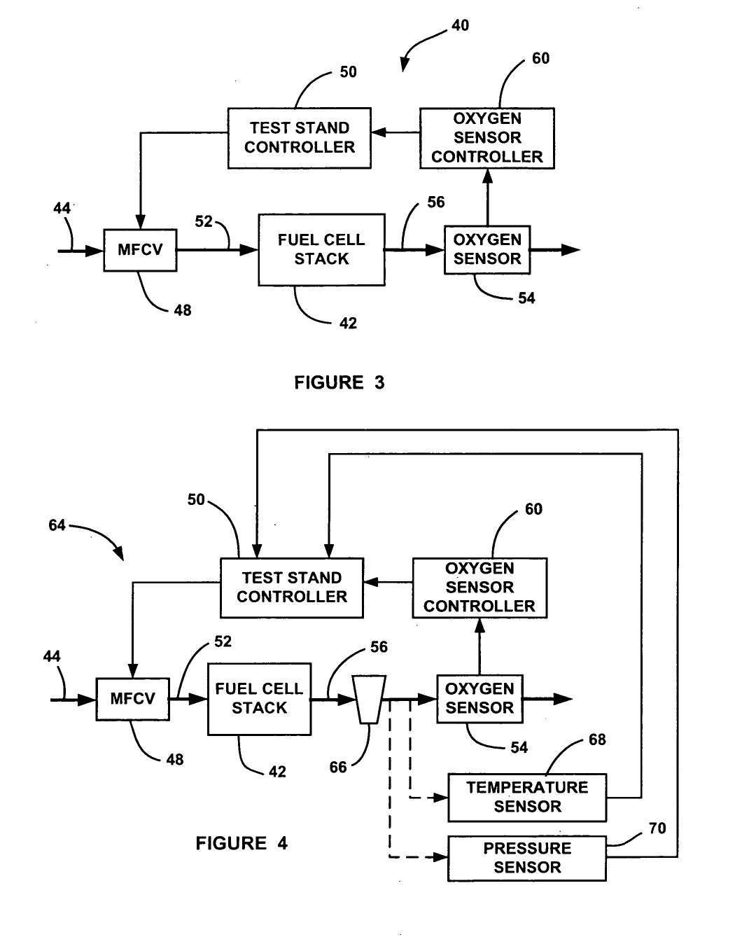

FIG. 3 is a block diagram of a fuel cell system 40 that is being tested in a test stand environment, according to another embodiment of the present invention. The fuel cell system 40 includes a fuel cell stack 42 having a stack of fuel cells, as discussed above. The fuel cell stack 42 receives a cathode air input and an anode hydrogen input that electrochemically interact to generate output power to drive a vehicle or some other system. Cathode charge air on an air input line 44 is sent to a mass flow control valve (MFCV) 48 that is controlled by a test stand controller 50 to provide the proper amount of charge air on a cathode input line 52 to the fuel cell stack 42. The anode input of the fuel cell stack 42 is not shown because it does not form part of the present invention. By controlling the valve position of the MFCV 48, the proper cathode stoichiometry is provided to the fuel cell stack 42 for the desired output power at any given point in time.

According to the invention, the system 40 employs an oxygen sensor 54 through which flows cathode exhaust gas from the stack 42 on a cathode exhaust line 56. The oxygen sensor 54 can be any oxygen sensor suitable for the purposes discussed herein, such as the known automotive exhaust oxygen sensor. The oxygen sensor 54 provides a signal indicative of the concentration of the oxygen in the cathode exhaust gas to an oxygen sensor controller 60. The oxygen sensor controller 60 is actually part of the oxygen sensor 54, and includes the electronics of the sensor 54 that are removed from the harsh environment of the cathode exhaust. The oxygen sensor controller 60 conditions the signal from the sensor 54 and provides a signal to the test stand controller 50 indicative of the amount of oxygen in the cathode exhaust gas. The test stand controller 50 will determine if the fuel cell stack 42 is receiving the proper amount of charge air based on a stoichiometric calculation. If the MFCV 48 is not supplying the proper concentration of charge gas to the cathode, the test stand controller 50 will control the valve position of the MFCV 48 accordingly so that the amount of oxygen in the cathode exhaust line is representative of the proper charge air stoichiometry applied to the fuel cell stack 42.

In the system 40, the relative humidity (RH) at the point of analysis is assumed. This assumption may or may not be accurate. It is possible that water vapor in the cathode exhaust will significantly impact the partial pressure of oxygen in the exhaust gas. Therefore, to accurately assess the actual oxygen content in the cathode exhaust, the RH of the exhaust gas should be determined. FIG. 4 is a block diagram of a fuel cell system 64, according to another embodiment of the present invention, that corrects for the exhaust gas relative humidity, where like elements are identified by the same reference numeral. In this embodiment, the cathode exhaust is sent through a water vapor separator 66 before being sent to the oxygen sensor 54 to remove the liquid water therefrom. However, the exhaust gas will be saturated with water vapor at the temperature and pressure at which it exits the water separator 66.

A temperature sensor 68 measures the temperature of the cathode exhaust gas between the water separator 66 and the oxygen sensor 54, and provides a signal indicative of the temperature to the test stand controller 50. Likewise, a pressure sensor 70 measures the pressure of the cathode exhaust gas between the water vapor separator 66 and the oxygen sensor 54, and provides a signal of the pressure to the test stand controller 50. The temperature sensor 68 can be any temperature sensor suitable for the purposes discussed herein, such as a thermocouple. Likewise, the pressure sensor 70 can be any pressure sensor suitable for the purposes discussed herein, such as a pressure transducer. The test stand controller 50 uses these measurements to calculate the water content of the exhaust gas and correct the impact it has on the partial pressure of oxygen. By determining the temperature and pressure of the cathode exhaust gas, the test stand controller 50 can determine the RH or water content of the exhaust gas to provide a proper measurement of the cathode stoichiometry.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

1. A fuel cell system comprising:
a fuel cell stack including a cathode input receiving a cathode input gas and a cathode output outputting a cathode exhaust gas;
an oxygen sensor responsive to the cathode exhaust gas, said oxygen sensor generating a sensor signal indicative of the oxygen concentration in the cathode exhaust gas; and
a system controller responsive to the sensor signal from the oxygen sensor, said controller controlling the flow of the cathode input gas applied to the stack so as to provide a desired cathode lambda.

2. The system according to claim 1 further comprising a compressor, said compressor being responsive to an air input and outputting the cathode input gas to the stack, said controller driving the compressor to provide the desired stoichiometry of oxygen in the cathode.

3. The system according to claim 1 further comprising an airflow meter, said airflow meter being responsive to the cathode input gas and providing an airflow signal indicative of the flow of the cathode input gas to the stack, said controller being responsive to the airflow signal.

4. The system according to claim 3 wherein the controller uses a combination of the sensor signal and the airflow signal to determine whether a leak exists between the airflow meter and the oxygen sensor.

5. The system according to claim 1 further comprising a back-pressure valve responsive to the cathode exhaust gas, said oxygen sensor being positioned between the stack and the back-pressure valve or downstream of the back-pressure valve.

6. The system according to claim 1 wherein the oxygen sensor is an automotive-type oxygen sensor.

7. The system according to claim 1 further comprising a water vapor separator responsive to the cathode exhaust gas upstream of the oxygen sensor, said water vapor separator removing water vapor from the cathode exhaust gas.

8. The system according to claim 1 further comprising a temperature sensor for measuring the temperature of the cathode exhaust gas, said temperature sensor providing a signal to the system controller to help determine the relative humidity of the cathode exhaust gas.

9. The system according to claim 1 further comprising a pressure sensor for measuring the pressure of the cathode exhaust gas, said pressure sensor providing a signal indicative of the pressure to the system controller to help determine the relative humidity of the cathode exhaust gas.

10. The system according to claim 1 wherein the controller uses a compressor map based on a compressor speed and a compressor input/output pressure ratio to help determine the cathode lambda.

11. The system according to claim 1 wherein the fuel cell system is a fuel cell system on a vehicle or a stationary power supply.

12. The system according to claim 1 wherein the fuel cell system is connected to a test stand.

13. The system according to claim 12 further comprising a mass flow control valve, said controller controlling the valve position of the mass flow control valve to provide the desired cathode lambda.

14. A fuel cell system comprising:
a fuel cell stack including a cathode input receiving a cathode air input gas and a cathode output outputting a cathode exhaust gas;
an oxygen sensor responsive to the cathode exhaust gas, said oxygen sensor generating a sensor signal indicative of the oxygen concentration in the cathode exhaust gas;
a compressor, said compressor being responsive to an air input and outputting the cathode input gas to the stack; and
a system controller, said controller being responsive to the sensor signal from the oxygen sensor, said controller driving the compressor to provide a desired concentration of oxygen in the cathode output gas.

15. The system according to claim 14 further comprising an airflow meter, said airflow meter being responsive to the air input or the cathode input gas and providing an airflow signal indicative of the flow of the cathode input gas to the stack, said controller being responsive to the airflow signal.

16. The system according to claim 15 wherein the controller uses a combination of the sensor signal and the airflow signal to help determine whether a leak exists between the airflow meter and the oxygen sensor.

17. The system according to claim 14 further comprising a back-pressure valve responsive to the cathode exhaust gas, said oxygen sensor being positioned between the stack and the back-pressure valve or downstream of the back-pressure valve.

18. The system according to claim 14 wherein the oxygen sensor is an automotive-type oxygen sensor.

19. The system according to claim 14 further comprising a water vapor separator responsive to the cathode exhaust gas upstream of the oxygen sensor, said water vapor separator removing water vapor from the cathode exhaust gas.

20. The system according to claim 14 further comprising a temperature sensor for measuring the temperature of the cathode exhaust gas, said temperature sensor providing a signal to the system controller to help determine the relative humidity of the cathode exhaust gas.

21. The system according to claim 14 further comprising a pressure sensor for measuring the pressure of the cathode exhaust gas, said pressure sensor providing a signal indicative of the pressure to the system controller to help determine the relative humidity of the cathode exhaust gas.

22. A fuel cell system comprising:
a fuel cell stack including a cathode input receiving a cathode input gas and a cathode output outputting a cathode exhaust gas;
an oxygen sensor responsive to the cathode exhaust gas, said oxygen sensor generating a sensor signal indicative of the oxygen concentration in the cathode exhaust gas;
a mass flow control valve for controlling the amount of cathode input gas sent to the fuel cell stack; and
a system controller, said controller being responsive to the sensor signal from the oxygen sensor, said controller controlling the valve postion of the mass flow control valve to provide a desired concentration of oxygen in the cathode output gas.

23. The system according to claim 22 wherein the oxygen sensor is an automotive-type oxygen sensor.

24. The system according to claim 22 further comprising a water vapor separator responsive to the cathode exhaust gas upstream of the oxygen sensor, said water vapor separator removing water vapor from the cathode exhaust gas.

25. The system according to claim 22 further comprising a temperature sensor for measuring the temperature of the cathode exhaust gas, said temperature sensor providing a signal to the system controller to help determine the relative humidity of the cathode exhaust gas.

26. The system according to claim 22 further comprising a pressure sensor for measuring the pressure of the cathode exhaust gas, said pressure sensor providing a signal indicative of the pressure to the system controller to help determine the relative humidity of the cathode exhaust gas.

27. A method of controlling a cathode lambda of a fuel cell system, said method comprising:
measuring the concentration of oxygen in a cathode exhaust gas from a fuel cell stack of the fuel cell system; and
controlling a cathode input gas applied to the fuel cell stack in response to the measured concentration of oxygen to provide the desired cathode lambda.

28. The method according to claim 27 wherein controlling the cathode input gas includes driving a compressor so that the proper amount of air is applied to the fuel cell stack to provide the desired cathode lambda.

29. The method according to claim 27 wherein controlling the cathode input gas includes controlling the valve position of a mass flow control valve so that the proper amount of air is applied to the fuel cell stack to provide the desired cathode lambda.

30. The method according to claim 27 further comprising measuring an airflow applied to the compressor.

31. The method according to claim 30 further comprising determining whether a leak exists from the measured airflow and the measured concentration of oxygen.

32. The method according to claim 27 further comprising separating water vapor from the cathode exhaust gas.

33. The method according to claim 27 further comprising measuring the temperature of the cathode exhaust gas to help determine the relative humidity of the cathode exhaust gas.

34. The method according to claim 27 further comprising measuring the pressure of the cathode exhaust gas to help determine the relative humidity of the cathode exhaust gas.
